(19) United States
(12) Patent Application Publication
(10) Pub. No.: US 2008/0294652 A1
(43) Pub. Date: Nov. 27, 2008

(54) Personalized Identification Of System Resources

(75) Inventors: Mitica Manu, Sammamish, WA (US); Patrick Michael Haluptzok, Sammamish, WA (US); Leroy B. Keely, Portola Valley, CA (US); Shawn R. LeProwse, Mercer Island, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/751,088

(22) Filed: May 21, 2007

(51) Int. Cl. G06F 17/00

(52) U.S. Cl. 707/100; 707/E17.005

(57) ABSTRACT

A processing device may display a representation of a system resource. The system resource may include a menu, a folder, a filename, a shortcut, a textbox, or other resource. The user may make a gesture to indicate a desire to create a personalized identifier for the system resource. The processing device may display a personalized identifier writing area for inputting personalized identifier information. Personalized identifier information may be input via text, speech, digital ink, or other methods. The processing device may permit the user to configure types of information to be stored with personalized identifiers and how the personalized identifier information may be indexed for searching. In one embodiment, the input personalized identifier information may be translated to a second language and indexed for searching. Further, the processing device may permit the user to configure whether or how to display a personalized identifier for a system resource.

### BACKGROUND

Operating systems manage system resources of processing devices and provide an environment in which application programs may execute. Operating systems typically identify system resources, such as, for example, a GUID (globally unique identifier), a filepath/name, an icon, a folder, or other system resource using a string of characters. Often, the string of characters identifying a system resource may appear to have no relation to the system resource from a user's perspective. In some cases, the string of characters may appear to be random and meaningless to the user. Because the string of characters may have no meaning to the user, the user may have difficulty distinguishing one string of characters for one system resource from another string of characters for another system resource.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a processing device may permit a user to create a personalized identifier to be displayed when a representation of a system resource is displayed. The personalized identifier may be separate from a system resource identifier, such as, for example, a GUID, a filepath/name, an icon, a folder, a menu, a shortcut, a textbox, or other system resource identifier. In some embodiments, the personalized identifier may be defined in addition to one or more system resource identifiers. In other embodiments, the personalized identifier may replace one or more system resource identifiers. The user may provide input for personalized identifier information via a number of methods including text from keyboard input, text from speech-to-text conversion, digital ink, or other methods.

The processing device may permit the user to configure types of information to store with personalized identifiers. The types of information may include text, digital ink, a local or remote recognition result from recognizing a digital ink, translated text, or other types of information. In one embodiment, the types of information may be stored in a personalized identifier information data structure.

The processing device may permit the user to configure whether or how a visual identifier may be displayed by the processing device. In some embodiments, the processing device maybe be configured to display a visual identifier whenever a representation of a system resource having corresponding personalized identifier information is displayed, whenever a writing device hovers over a displayed representation of a system resource, or never.

Personalized identifier information corresponding to system resources may be indexed, such that system resources may be searchable based on corresponding personalized identifier information. Types of personalized identifier information to be indexed may be configurable in some embodiments.

### DRAWINGS

In order to describe the manner in which the above-recited and other advantages and features can be obtained, a more particular description is provided below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIGS. 1 illustrates an exemplary operating environment for an embodiment consistent with the subject matter of this disclosure.

FIG. 2 is a functional block diagram of a processing device for implementing embodiments consistent with the subject matter of this disclosure.

FIG. 3 illustrates an exemplary display showing a representation of a system resource and a corresponding identifier.

FIG. 4 shows an exemplary display for permitting a user to configure types of information to store with identifiers and types of identifier information to be used for indexing purposes.

FIG. 5 illustrates an exemplary display for permitting a user to configure whether a visual identifier for a system resource is to be displayed and a type of information to be displayed as the visual identifier.

FIGS. 6-10 and 12 are flowcharts of exemplary processes that may be performed in embodiments consistent with the subject matter of this disclosure.

FIG. 11 illustrates an exemplary identifier data structure that may be employed by a processing device consistent with the subject matter of this disclosure.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Overview

In embodiments consistent with the subject matter of this disclosure, a processing device and method are provided which permit a user to configure a personalized identifier for a system resource of the processing device. The personalized identifier may be separate from a system resource identifier, such as, for example, a GUID, a filepath/name, an icon, a folder, a menu, a shortcut, a textbox, or other system resource identifier. In some embodiments, the personalized identifier may be defined in addition to one or more system resource identifiers. In other embodiments, the personalized identifier may replace one or more system resource identifiers.

The processing device may include a keyboard to input characters, numbers, or other symbols, a microphone and a speech recognition component for converting speech to text, or a display and a writing device for entering input as one or more strokes of digital ink. A stroke of digital may begin when a writing instrument lands on a writing surface, and may end when the writing instrument is lifted off the writing surface. In some embodiments, the user may make a gesture to indicate a desire to create an identifier for a system resource. The gesture may include right-clicking with a pointing device, such as, for example, a computer mouse, while hovering over a displayed representation of the system resource, pressing a particular keyboard key while a focus is on the displayed representation of the system resource, making a particular stroke or group of strokes with a writing device on the displayed representation of the system resource, speaking a command into a microphone, or other actions.

After the user indicates a desire to create a personalized identifier for the system resource, an identifier writing area may be displayed for the user to input information for the personalized identifier. In some embodiments, the writing area may resemble a note. The user may enter input information by, for example, typing on a keyboard, using a writing device to enter one or more strokes of digital ink, speaking into a microphone and using a speech recognition component to convert speech to text, or other input methods.

In some embodiments, the user may configure the processing device to recognize the input digital ink for the identifier either locally, on the processing device, or remotely, on a second processing device. That is, the input strokes of digital ink for the identifier may be recognized, either locally or remotely, to produce a recognition result. Further, the user may configure the processing device, such that, for example, identifier information including text, or a recognition result including text, may be translated from a first language to a second language. The translation may be performed locally, on the processing device, or remotely, on a second processing device. The user may further configure the processing device to store certain items of information in a personalized identifier data structure, such as, standard text input, digital ink input, a recognition result as text, translated text, or other information.

In various embodiments, a user may configure whether or how a personalized identifier of a system resource is displayed by the processing device. For example, the user may configure the processing device, such that a visual identifier of a system resource is never displayed, always displayed, or only displayed when a writing device hovers over a displayed representation of the system resource. In some embodiments, other configuration options for displaying a visual identifier may be provided.

Further, in at least some embodiments, system resources may be indexed for searching based on input identifier information. The system resources may be indexed according to personalized identifier information text, a recognition result of recognizing digital ink input for a personalized identifier, translated text translated from a standard text input, text resulting from conversion of speech input, or other personalized identifier input.

### Exemplary Processing Device

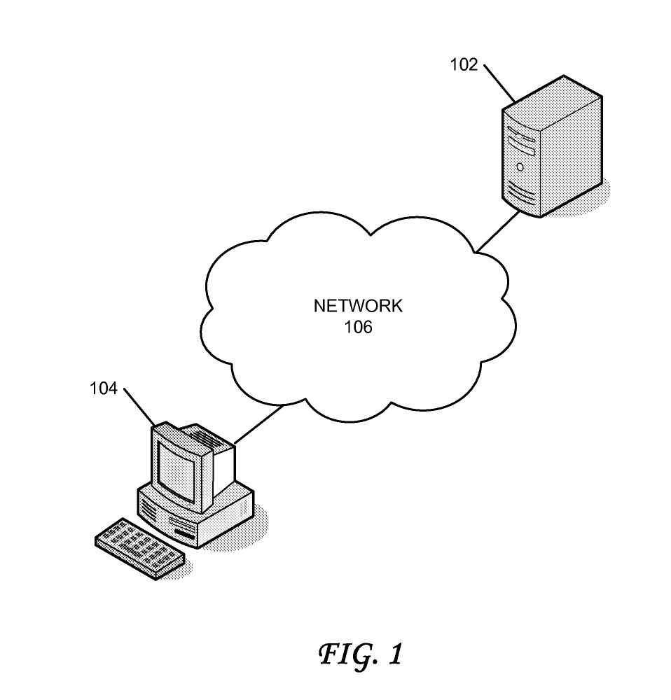

FIG. 1 illustrates an exemplary environment in which embodiments consistent with the subject matter of this disclosure may operate. The exemplary environment may include a first processing device 102, a second processing device 104, and a network 106.

First processing device 102 may be a server, a desktop personal computer (PC), a notebook PC, a tablet PC, a handheld processing device, a personal digital assistant (PDA) or other processing device.

Second processing device 104 may be a user's processing device, such as, for example, a desktop PC, a notebook PC, a tablet PC, a handheld processing device, a PDA, or other processing device.

Network 106 may be a single network or a number of connected networks, such as, for example, the Internet, or other networks. In some embodiments, network 106 may include wired networks, as well as wireless networks. First processing device 102 and second processing device 104 may access network 106 via a wired connection, a wireless connection, or other type of connection.

In some embodiments, a user's processing device, such as, second processing device 104, may be a standalone device. In such embodiments, the second processing device 104 may implement embodiments consistent with the subject matter of this disclosure without being connected to a network and a second processing device.

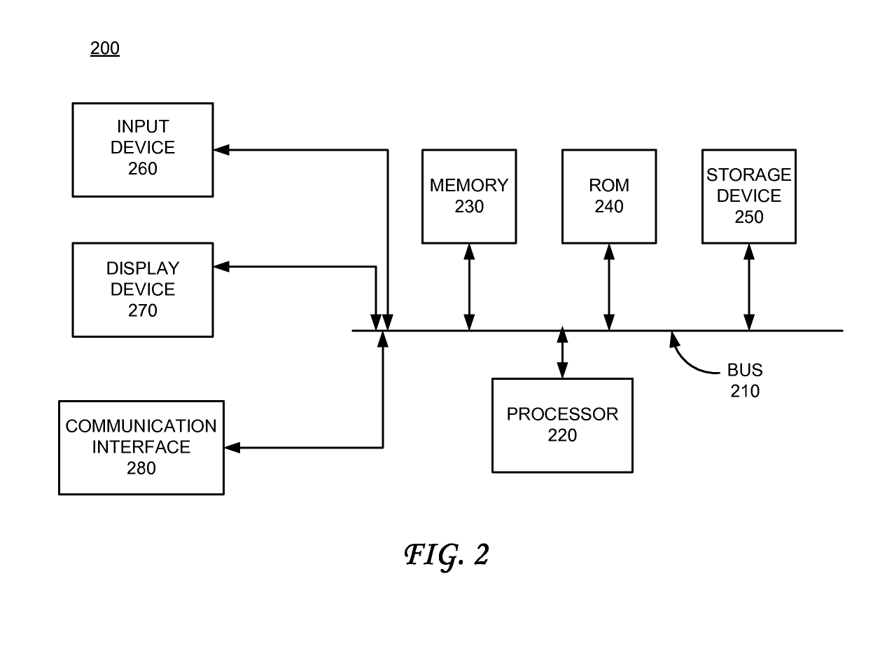

FIG. 2 is a functional block diagram that illustrates an exemplary processing device 200, which may be used to implement embodiments consistent with the subject matter of this disclosure. Processing device 200 may include a bus 210, a processor 220, a memory 230, a read only memory (ROM) 240, a storage device 250, an input device 260, an output device 270, and a communication interface 280. Processing device 200 may be a desktop personal computer (PC), a notebook PC, a handheld processing device, a tablet PC, or other type of processing device.

Processor 220 may include at least one conventional processor or microprocessor that interprets and executes instructions. Memory 230 may be a random access memory (RAM), a Flash memory, or another type of dynamic storage device that stores information and instructions for execution by processing device 220. Memory 230 may also store temporary variables or other intermediate information used during execution of instructions by processing device 220. ROM 240 may include a conventional ROM device or another type of static storage device that stores static information and instructions for processing device 220. Storage device 250 may include any type of media for storing data and/or instructions.

Input device 260 may include one or more conventional mechanisms that permit a user to input information to processing device 200, such as, for example, a keyboard, a mouse, a touch screen, a microphone, or other input device. In some embodiments, input device 260 may include a touch screen and a writing device for writing on the touch screen. For example, input device 260 may include a writing device, such as, a user's own finger, a stylus, an electronic pen or a non-electronic pen, or other instrument. Output device 270 may include one or more conventional mechanisms that output information to the user, including one or more displays, or other output devices. Bus 210 may permit communication among components of processing device 200.

Processing device 200 may perform such functions in response to processor 220 executing sequences of instructions contained in a tangible machine-readable medium, such as, for example, memory 230, or other medium. Such instructions may be read into memory 230 from another machine-readable medium, such as storage device 250, or from a separate device via communication interface 280, which may provide a wired, wireless, optical, or other interface to a network or other processing device. In embodiments in which processing device 200 is a standalone processing device, processing device 200 may not include communication interface 280.

### Exemplary Displays

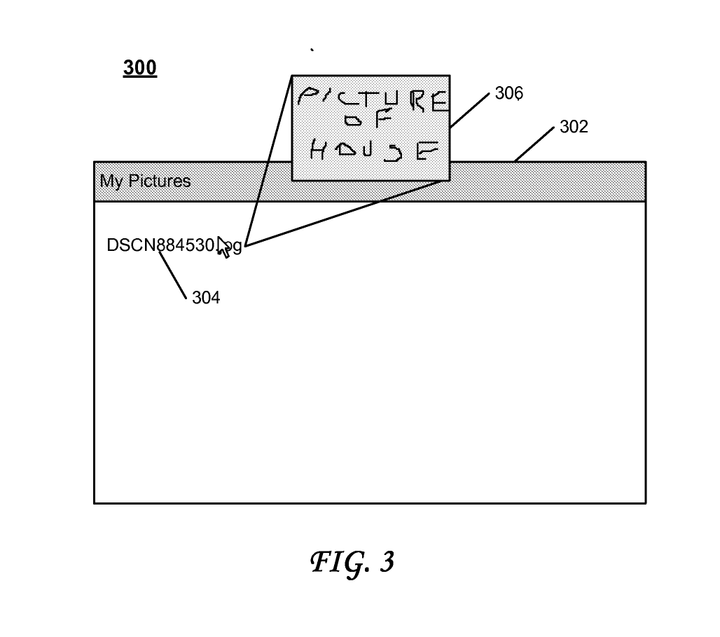

FIG. 3 shows an exemplary display 300 of a user's processing device, such as second processing device 104. Display 300 may include a window 302, representing a folder named “My Pictures”. “My Pictures” may include a file 304 named “DSCN884530.jpg”. In this example, file 304 is an image file, which includes a picture of the house. The filename “DSCN884530.jpg” may not convey any information about the file to the user. Once the user understands that file 304 is a picture of a house, the user may indicate a desire to create a personalized identifier for a system resource, which in this case is file 304. The user may indicate the desire to create the personalized identifier by making a gesture, such as, for example, right-clicking on a pointing device while hovering over a displayed representation of the system resource, pressing a key on a keyboard while a focus is on the displayed representation of the system resource, making one or more particular strokes of digital ink over the displayed representation of the system resource with a writing device, or via other actions.

Once the user indicates the desire to create the personalized identifier for the system resource, a writing area, such as, a writing area 306 may be displayed. The user may input personalized identifying information to writing area 306 via a number of different input methods. For example, the user may type the personalized identifying information via keys on a keyboard, the user may speak into a microphone and the processing device may include a speech recognition component, which may convert input speech into text, the user may enter one or more strokes of digital ink onto writing area 306 with a writing device, or the user may provide input via other input methods. In this example, the user may input multiple strokes of digital ink onto writing area 306.

Later, when the processing device again displays a representation of file 304, the processing device may display the corresponding personalized identifier informing the user of contents of file 304 with a user-created personalized identifier.

With respect to the example of FIG. 3, the folder “My Pictures” is also a system resource, for which the user may create a personalized identifier. The user may create the personalized identifier in a same manner as discussed above with respect to file 304. As mentioned previously, the user may create a personalized identifier for a number of different system resources, including, but not limited to, a menu, a folder, a filename, a shortcut, a textbox, or other resource.

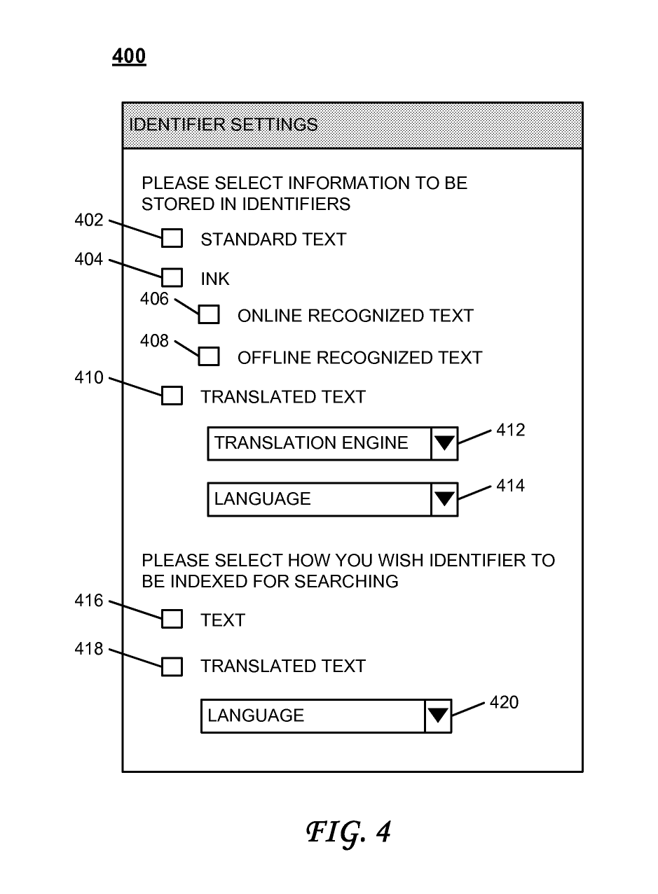

In some embodiments consistent with the subject matter of this disclosure, identifier information for a personalized identifier may be stored in a personalized identifier data structure. The user's processing device may provide the user with an ability to configure the user's processing device with respect to types of personalized identifier information to be stored in the personalized identifier data structure. FIG. 4 illustrates an exemplary display 400, which the user's processing device may present to the user for the user to select the types of information to be stored in the personalized identifier data structure.

Display 400 may include a number of checkboxes that the user may select, indicating one or more types of data to be stored in the personalized identifier data structure. For example, selection of checkbox 402 may indicate that standard text input from a keyboard, from speech to text conversion by the user's processing device, or from another input source is to be stored in the personalized identifier data structure. Selection of checkbox 404 may indicate that a representation of the digital ink input is to be stored in the personalized identifier data structure. Selection of checkbox 406 or 408 may indicate that a recognition result from performing recognition of input digital ink identifier information locally or on a remote processing device, respectively, is to be stored in the personalized identifier data structure. Checkbox 410 may indicate that translated text, from translating personalized identifier information from a first language to a second language, may be stored in the personalized identifier data structure.

Further, in some embodiments, the user may select a translation engine for translating personalized identifier information. For example, the user may select a drop-down menu 412, thereby causing a display of names of one or more translation engines to be displayed. The user may select one or more of the translation engines from the drop-down menu. Further, the user may select one or more languages to which personalized identifier information may be translated. The user may select the one or more languages by selecting drop-down menu 414, which may cause a menu to be presented listing a number of languages. The user may then select one or more languages from the menu. Thus, in some embodiments, multiple text translations of the personalized identifier information may be stored in the personalized identifier data structure.

Further, the user may select which personalized identifier information is to be indexed for searching by selecting one or more checkboxes. For example, selection of checkbox 416 may cause the user's processing device to index system resources and corresponding personalized identifier information by text, which may have been input via a keyboard, via a microphone, via a recognition result of recognizing digital ink input, or by another input method. Further, selection of checkbox 418 may cause the user's processing device to index the system resources and the corresponding personalized identifier information by translated text. The user may select one or more languages of the translated text for indexing by selecting drop-down menu 420 and choosing one or more languages from the presented menu.

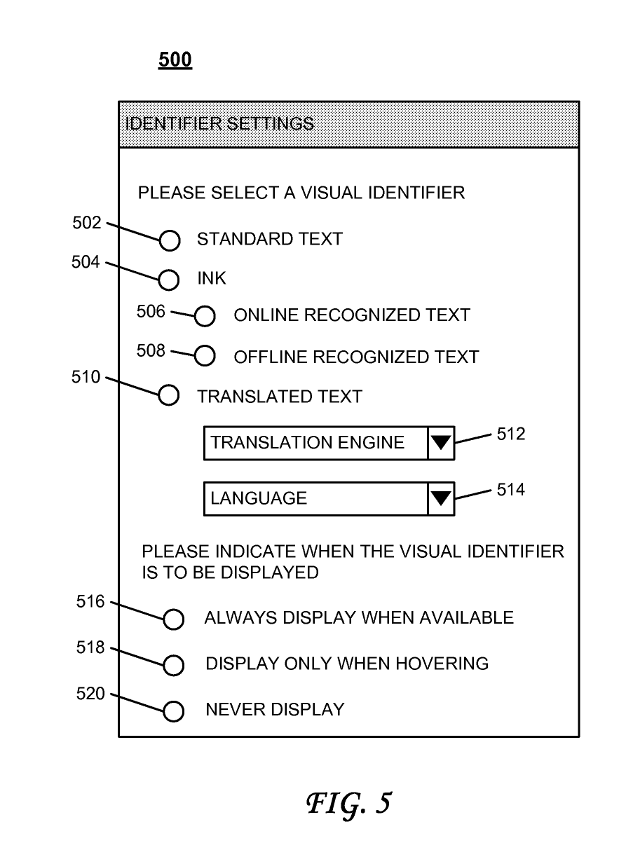

FIG. 5 illustrates an exemplary display 500, which may be presented to a user via a user's processing device, such as, for example, second processing device 104. Display 500 may permit the user to select how visual identifiers for system resources are to be displayed by the user's processing device. The user may select button 502 to configure the user's processing device to display standard text as the visual identifier. The user may select button of 504 to configure the user's processing device to display digital ink as a visual identifier (assuming personalized identifier information was input as digital ink). The user may select button 506 to configure the user's processing device to display a locally processed recognition result with respect to a digital ink portion of the personalized identifier information. The user may select button 508 to configure the user's processing device to display a remotely processed recognition result with respect to the digital ink portion of the personalized identifier information. The user may select button 510 to configure the user's processing device to display translated text with respect to the personalized identifier information. The user may select a translation engine for to produce the translated text by selecting a drop-down menu 512 and further selecting one of a number of listed translation engines from a presented menu. One or more languages for the translated text to be displayed may be configured by the user selecting drop-down menu 514 and further selecting one of a number of listed languages from a presented menu.

The user may also select whether or when a visual identifier is to be displayed by the user's processing device. The user may select button 516 to configure the user's processing device to always display a personalized identifier for a system resource, when the identifier is available. The user may select button 518 to configure the user's processing device to display a personalized identifier for a system resource, when the personalized identifier is available and a writing device hovers over a displayed representation of a system resource. The user may select button 520 to configure the user's processing device to never display a personalized identifier for a system resource.

Display 500 is an exemplary display. In other embodiments, different or other options may be presented for the user to configure display characteristics of the user's processing device.

In various embodiments, displays such as, for example, exemplary displays 400 and 500, or other displays, may permit the user to configure the user's processing device on a system-wide basis, on an application basis, on a session basis, on a system resource type basis, or on another basis.

### Exemplary Processing

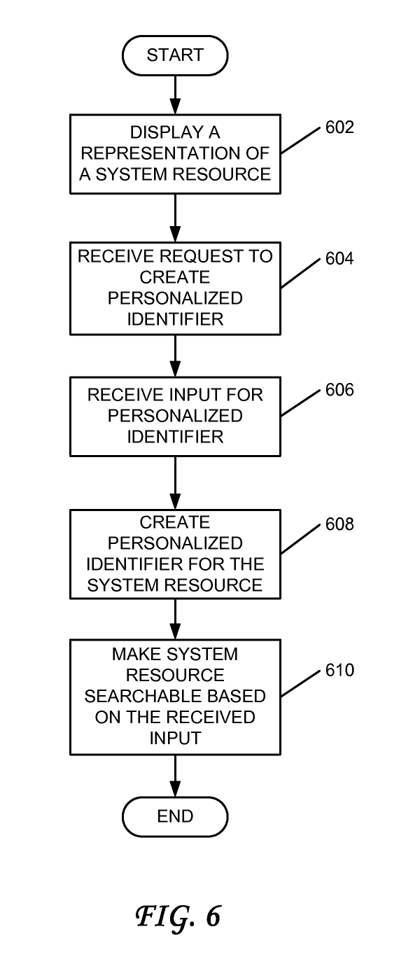

FIG. 6 illustrates an exemplary process which may be performed in embodiments consistent with the subject matter of this disclosure. The process may begin with a user's processing device, such as, for example, second processing device 104, displaying a representation of a system resource (act 602). The system resource may be a menu, a folder, a filename, a shortcut, a textbox, an icon, or other resource. The user's processing device may receive a request to create a personalized identifier for the system resource (act 604). The user may indicate a desire to create the personalized identifier by making a gesture, such as, for example, right-clicking a computer mouse, pressing a particular button or sequence of buttons on a keyboard, speaking a command into a microphone, making one or more particular sequences of strokes with a writing device in an area of a display in which a representation of the system resource is presented, or via other methods. The user's processing device may then receive personalized identifier information for the personalized identifier (act 606). The personalized identifier information may be in various input forms, such as, for example, digital ink, speech, text from a keyboard, or other input forms.

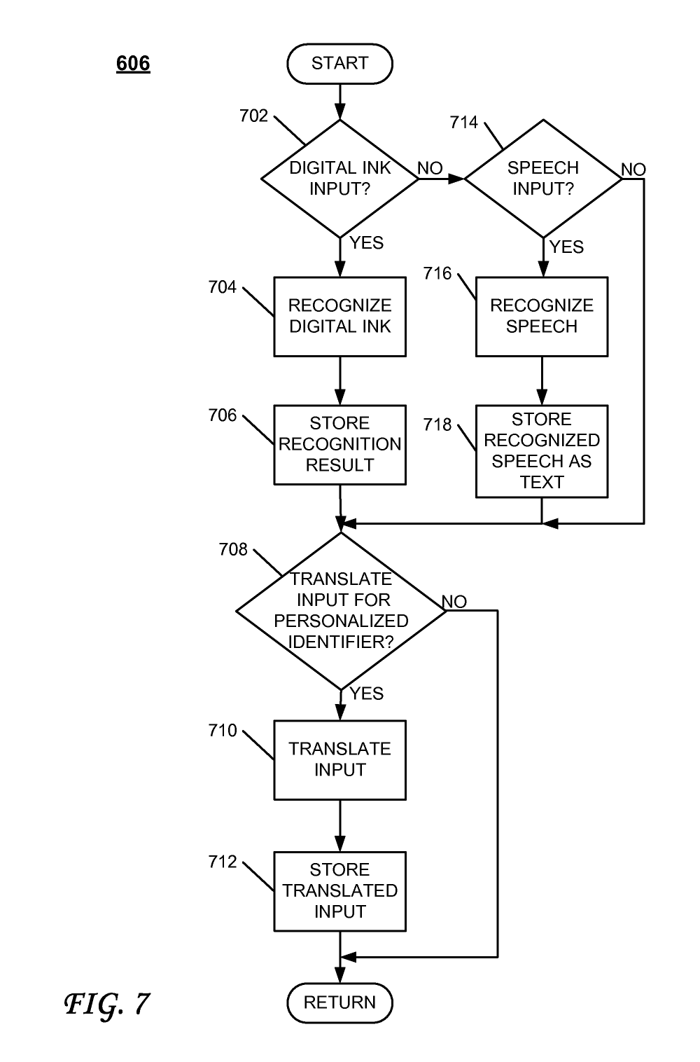

FIG. 7 is a flowchart which illustrates an exemplary process for performing act 606 in one embodiment consistent with the subject matter of this disclosure. The process may begin with the user's processing device determining whether the input is digital ink input (act 702; FIG. 7). If the input is not digital ink input, then the user's processing device may determine whether the input is speech input (act 714). If the input is speech input, then the user's processing device may recognize the speech and may produce text from the recognize speech (act 716). The user's processing device may then store the produced text (act 718).

If, during act 702, the user's processing device determines that the input is digital ink input, then the digital ink input may be recognized to produce a recognition result, which in some embodiments may be text, symbols, a chemical formula, a mathematical expression, or other recognized result (act 704).

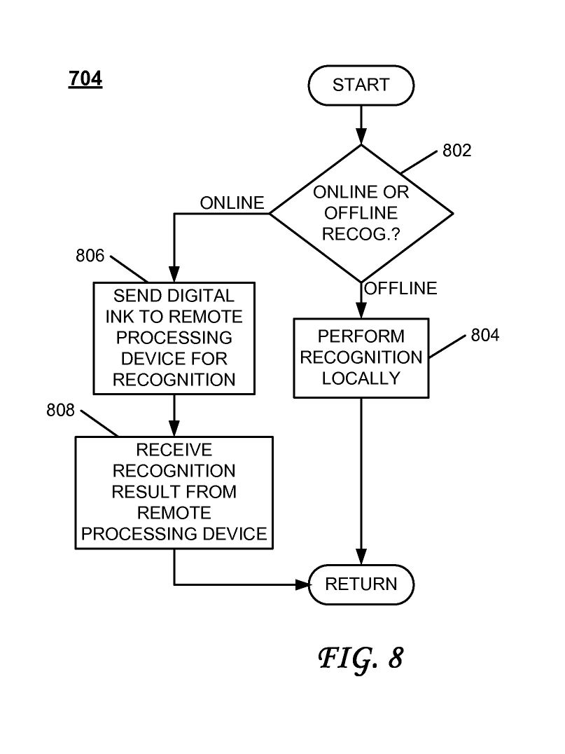

FIG. 8 is a flowchart which illustrates an exemplary process for performing act 704 in one embodiment consistent with the subject matter of this disclosure. The process may begin with the user's processing device determining whether the digital ink is to be recognized offline (locally, on the user's processing device), or online (remotely, on a remote processing device) (act 802; FIG. 8). If the user's processing device determines that the digital ink is to be recognized locally, then the user's processing device may recognize the digital ink and may produce a recognition result (act 804).

If, during act 802, the user's processing device determines that the digital ink is to be recognized online, then the user's processing device may send a representation of the digital ink to a remote processing device, such as, for example, first processing device 102, via a network, such as, for example, network 106 (act 806). The remote processing device may recognize the digital ink, may produce a recognition result, and the user's processing device may receive the recognition result from the remote processing device via the network (act 808).

Returning to FIG. 7, the user's processing device may store the recognition result (act 706; FIG. 7). After storing the recognition result during act 706, after storing the recognize speech as text during act 718, or after determining that the input is not speech (an assumption is made in this example that if the input is not digital ink and is not speech, then it is text), then the user's processing device may determine whether the input is to be translated to another language (act 708). If the input is to be translated, then text corresponding to the input may be translated (act 710).

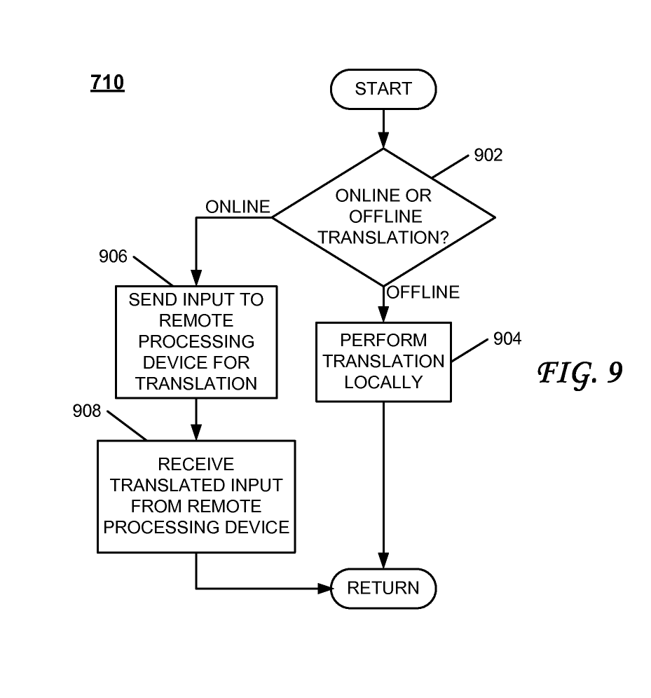

FIG. 9 is a flowchart which illustrates an exemplary process for performing act 710 in one embodiment consistent with the subject matter of this disclosure. The process may begin with the user's processing device determining whether translation is to be performed offline (locally, on the user's processing device), or online (remotely, on a remote processing device) (act 902; FIG. 9). If the user's processing device determines that translation is to be performed offline, then the user's processing device may translate the text corresponding to the input to produce a translated input (act 904).

If, during act 902, the user's processing device determines that translation is to be performed online, then the user's processing device may send the text corresponding to the input to a remote processing device, such as, for example, first processing device 102, or another remote processing device, via a network, such as, for example, network 106, for translation to produce the translated input (act 906). After the remote processing device translates the text corresponding to the input and produces the translated input, the user's processing device may receive the translated input from the remote processing device via the network (act 908).

Returning to FIG. 7, the user's processing device may store the translated input (act 712; FIG. 7).

Returning to FIG. 6, the user's processing device may create the personalized identifier for the system resource based on the received personalized identifier information (act 608, FIG. 6). The user's processing device may then make the system resource searchable based on the received input (act 610). In one embodiment, the user's processing device may make the system resource searchable according to a configuration based on configuration inputs provided via a display, such as, for example, display 400, or other display. In another embodiment, when the user attempts to search for a system resource based on digital ink input including shapes, the digital ink input may be compared with digital ink identifier information by calculating a distance, such as a Chebyshev distance, or other distance, between the digital ink input and the digital ink identifier information. If the calculated distance is within a predetermined range, then a matching identifier and corresponding system resource is found.

The processes described above are only exemplary. In other embodiments, different or other acts may be performed. For example, in other embodiments, multiple translations may be performed, either locally or remotely, and stored in a personalized identifier data structure, according to a configuration of the user's processing device.

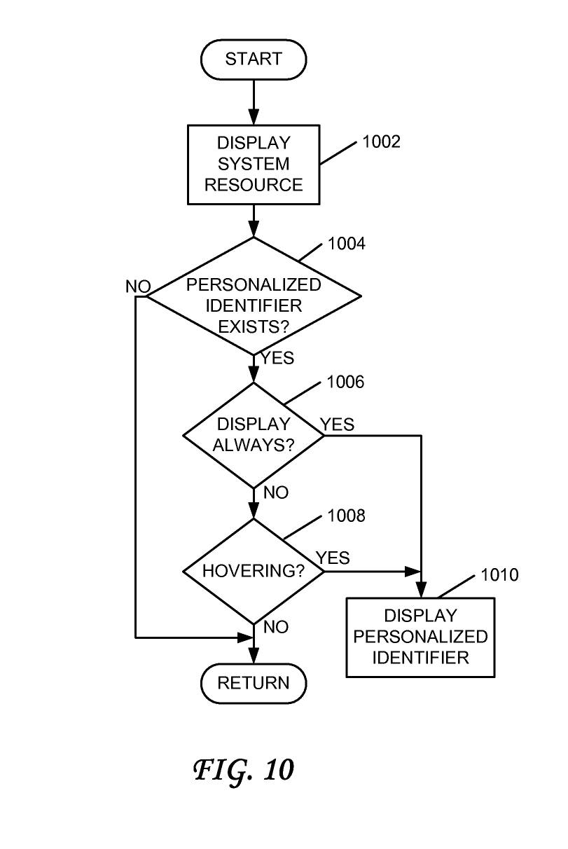

FIG. 10 is a flowchart illustrating an exemplary process with respect to displaying a personalized identifier of a system resource. The process may begin with a user's processing device, such as, for example, second processing device 104, displaying a representation of a system resource, such as, for example, a menu, a folder, filename, a shortcut, a textbox, or other resource (act 1002). The user's processing device may then determine whether the system resource has a corresponding personalized identifier (act 1004). If the user's processing device determines that the system resource does not have a corresponding identifier, then the process is completed.

Otherwise, the user's processing device may determine whether the user's processing device is configured to always display a personalized identifier for a system resource (act 1006). If the user's processing device is configured to always display a personalized identifier for a system resource, then the user's processing device may display the personalized identifier (act 1010).

If, during act 1006, the user's processing device determines that the user's processing device is not configured to always display a personalized identifier for a system resource, then, the user's processing device may determine whether the writing device is hovering over a displayed representation of the system resource (act 1008), and if so, the user's processing device may display the personalized identifier corresponding to the system resource (act 1010).

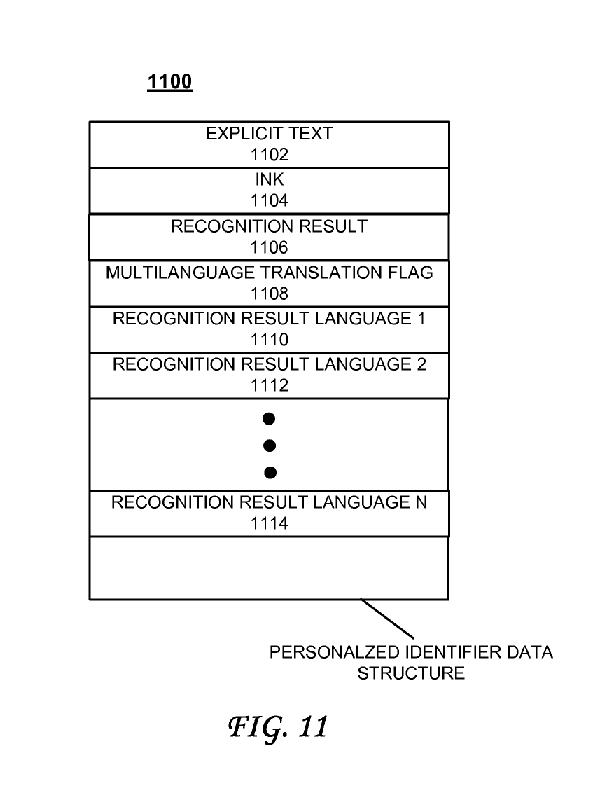

Previously, with respect to FIG. 4, exemplary display 400 illustrated how a user may configure the user's processing device to store certain types of information in a personalized identifier data structure. FIG. 11 illustrates an exemplary personalized identifier data structure 1100, which may be used by the user's processing device in one embodiment consistent with the subject matter of this disclosure. Personalized identifier data structure 1100 may include explicit text 1102, ink 1104, recognition result 1106, multilanguage translation flag 1108, recognition result language one 1110, recognition result language two 1112, . . . , and recognition result language N 1114, as well as other information.

Explicit text 1102 may be text from a keyboard, text produced as a result of speech recognition, or text from another source. Ink 1104 may be digital ink input as personalized identifier information. The digital ink may be input as one or more strokes to form text, mathematical expressions, chemical formulas, geometric shapes, drawings, or other objects. Recognition result 1106 may be a result of recognition of the digital ink input. Multilanguage translation flag 1108 may indicate whether multiple translations have been performed. In one embodiment, multilanguage translation flag 1108 may include a numeric value indicating a number of translations. Recognition result language one 1110, recognition result language two 1112, . . . , recognition result language N may correspond to results of translation of identifier information in corresponding languages, where a number of recognition result languages may correspond to the numeric value included in multilanguage translation flag 1108. In some embodiments, recognition result 1106 and recognition result language one 1110 through recognition result language N 1114 may include lattices of recognition results or a pointer to lattices of recognition results.

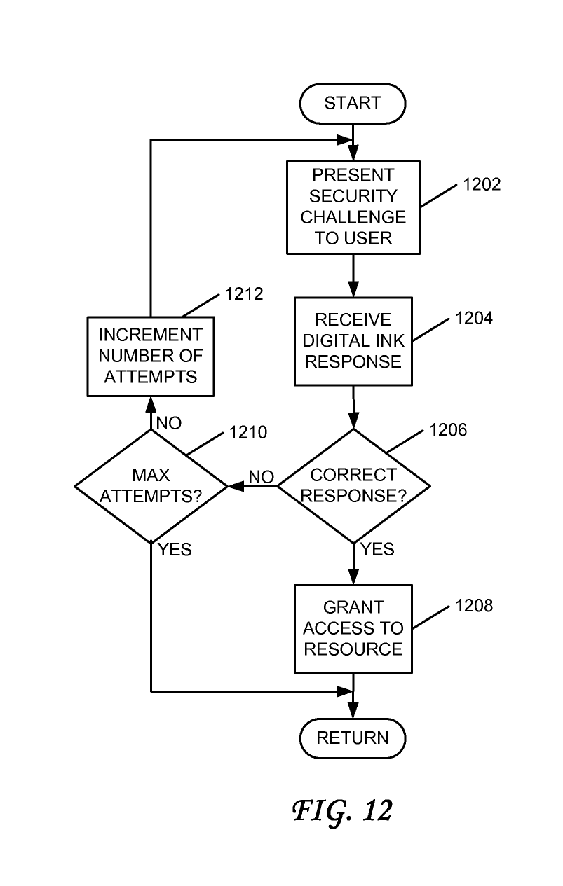

FIG. 12 is a flowchart of an exemplary process, which may be performed in an embodiment consistent with the subject matter of this disclosure. The exemplary process illustrates another way in which digital ink may be used. The process may begin with a processing device, such as, for example, second processing device 104, presenting a security challenge to a user wishing to access a resource (act 1202). The challenge may be presented as a question, in text, may be presented as an image, may be presented as a digital ink drawing, or may be presented in a number of other ways. The user may receive the challenge and may know a proper response to provide, as digital ink, as pre-arranged. The processing device may receive the digital ink response from the user (act 1204). The processing device may then determine whether the received digital ink response is a correct response (act 1206). In one embodiment, the digital ink response may include one or more strokes forming textual characters, symbols, or numbers. In another embodiment, the digital ink response may include one or more strokes forming one or more shapes. In an embodiment in which the digital ink response may include one or more strokes forming one or more shapes, the digital ink response may be compared with an expected response by determining a distance, such as a Chebyshev distance, or other distance from the expected response. If the determined distance is within a predetermined range, then the digital ink response may be considered to be correct.

If the digital ink response is determined to be correct, during act 1206, then the processing device may grant the user access to the resource (act 1208). Otherwise, the processing device may determine whether a maximum number of unsuccessful attempts have been made by the user to access the resource (act 1210). If the maximum number of unsuccessful attempts have been made by the user to access the resource, then the process may end without granting the user access to the resource. If the maximum number of unsuccessful attempts have not been made, then the processing device may increment a number of unsuccessful attempts made by the user (act 1212) and the processing device may repeat acts 1202-1212.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

1. A machine-implemented method for creating a personalized identifier for a system resource of a processing device, comprising:
displaying a representation of the system resource on a display screen of the processing device;
receiving input for the personalized identifier of the system resource, the personalized identifier being separate from a system resource identifier;
creating the identifier of the system resource; and
making the system resource searchable based on the received input.

2. The machine-implemented method of claim 1, wherein:
the received input includes at least one stroke of digital ink, and making the system resource searchable based on the received input further comprises:
comparing, when a search is requested, search input with the at least one stroke of digital ink using a distance calculation; and
presenting a representation of the system resource as a search result when the distance calculation is less than a predetermined value.

3. The machine-implemented method of claim 1, further comprising:
presenting a security challenge to a user;
receiving a predetermined response to the security challenge as digital ink; and
granting the user access to a resource after receiving the predetermined response to the security challenge.

4. The machine-implemented method of claim 1, further comprising:
performing recognition of speech input or at least one stroke of digital ink, included in the received input, to produce a recognition result; and
storing the recognition result, wherein:
making the system resource searchable based on the received input further comprises:
indexing the system resource based on the recognition result.

5. The machine-implemented method of claim 1, further comprising:
performing recognition of at least one stroke of digital ink, included in the received input, to produce a recognition result; and
storing the recognition result, wherein
the recognition result and a representation of the digital ink are stored in a data structure.

6. The machine-implemented method of claim 1, further comprising:
performing recognition of speech input or at least one stroke of digital ink, included in the received input, to produce a recognition result;
translating the recognition result from a first language to a second language, wherein:
making the system resource searchable based on the received input further comprises:
indexing the system resource based on the translated recognition result in the second language.

7. The machine-implemented method of claim 1, further comprising:
permitting a user to configure one or more types of information to be stored with the identifier.

8. A processing device comprising:
a processor;
a memory including instructions for the processor; and
a bus connecting the processor and the memory, the instructions further comprising:
instructions for creating a personalized identifier for a system resource based on received input, the personalized identifier being separate from a system resource identifier, and
instructions for indexing the system resource for searching based on the personalized identifier.

9. The processing device of claim 8, wherein the instructions further comprise:
instructions for permitting a user to configure display characteristics of the personalized identifier.

10. The processing device of claim 8, wherein the instructions further comprise:
instructions for permitting a user to configure display characteristics of the personalized identifier, wherein the display characteristics include at least one of a standard text display, a digital ink display, or a translated text display.

11. The processing device of claim 8, wherein the instructions further comprise:
instructions for permitting a user to configure the processing device to display the personalized identifier for a system resource when a pointing device or a writing device hovers over a displayed representation of the system resource.

12. The processing device of claim 8, wherein the instructions further comprise:
instructions for permitting the user to configure the processing device to translate the received input from a first language to a second language.

13. The processing device of claim 8, wherein the instructions further comprise:
instructions for permitting the user to configure the processing device to recognize speech input or at least one stroke of digital ink included in the received input and to produce a recognized result.

14. The processing device of claim 8, wherein the instructions further comprise:
instructions for permitting the user to configure the processing device to submit for recognition at least one stroke of digital ink included in the received input to a second processing device via a network and to store a recognized result received from the second processing device.

15. A tangible machine-readable medium having instructions recorded thereon for at least one processor, the instructions comprising:
instructions for receiving at least one stroke of digital ink as a personalized identifier for a system resource of a processing device, the personalized identifier being separate from a system resource identifier; and
instructions for indexing the system resource for a searching operation based on the received at least one stroke of digital ink.

16. The tangible machine-readable medium of claim 15, wherein the system resource includes a menu, a folder, a filename, a shortcut, or a textbox

17. The tangible machine-readable medium of claim 15, further comprising:
instructions for recognizing the at least one stroke of digital ink and producing a recognition result; and
instructions for displaying the recognition result when a pointing device or a writing device hovers over a displayed representation of the system resource.

18. The tangible machine-readable medium of claim 15, further comprising:
instructions for submitting a representation of the at least one stroke of digital ink to a remote processing device for recognition;
instructions for receiving and storing a recognition result from the remote processing device in response to submitting the representation of at least one stroke of digital ink; and
instructions for displaying the recognition result when a pointing device or a writing device hovers over a displayed representation of the system resource.

19. The tangible machine-readable medium of claim 15, further comprising:
instructions for participating in recognizing the at least one stroke of the digital ink and storing a recognition result; and
instructions for participating in translating the recognition result from a first language to a second language to produce a translated result, wherein
the instructions for indexing the system resource for a searching operation based on the received at least one stroke of digital ink further comprises:
instructions for indexing the system resource for a searching operation based on the translated result.

20. The tangible machine-readable medium of claim 15, further comprising:
instructions for participating in recognizing the at least one stroke of digital ink and storing a recognition result; and
instructions for submitting the recognition result to a remote processing device for translating from a first language to a second language to produce a translated result; and
instructions for receiving the translated result from the remote processing device and storing the translated result, wherein
the instructions for indexing the system resource for a searching operation based on the received at least one stroke of digital ink further comprise:
instructions for indexing the system resource for a searching operation based on the translated result.
